(19) United States
(12) Patent Application Publication
(10) Pub. No.: US 2008/0183814 A1
(43) Pub. Date: Jul. 31, 2008

(54) REPRESENTING ONLINE PRESENCE FOR GROUPS

(75) Inventor: Mehul Kirtikant Sanghavi, Sunnyvale, CA (US)

Correspondence Address: BEYER WEAVER LLP/Yahoo, P.O. BOX 70250, OAKLAND, CA, 94612-0250, US

(73) Assignee: YAHOO! INC., Sunnyvale, CA (US)

(21) Appl. No.: 11/668,106

(22) Filed: Jan. 29, 2007

(51) Int. Cl. G06F 15/16

(52) U.S. Cl. 709/204

(57) ABSTRACT

Methods and apparatus are described for communicating an online presence of a group in a network. The group includes at least one member associated with the network. Each member of the group has an independent online status. A group presence indicator corresponding to the group is presented in a first interface in the network. The group presence indicator represents an online status of the group as being online or offline. The online status of each member of the group is not apparent from the group presence indicator.

### BACKGROUND OF THE INVENTION

The present invention relates to techniques for communicating online status for groups in a network.

Messaging systems on the Web or mobile networks often provide some mechanism by which a user can indicate his current status to others on the network as well as monitor the online status of other users. An example of such a mechanism (illustrated in FIG. 1) is provided in messaging interface 100 of the popular Yahoo! Messenger application created by Yahoo! Inc. of Sunnyvale, Calif. As shown at 102, an icon (i.e., a “smiley face” in this example) and an associated status designation (i.e., “Available”) are associated with the user's screen name. This indicates the user's current online status to the user himself. And as illustrated in 104, this “online presence indicator” or OPI may also be represented in the contact lists of other users in the system to whom the user has elected to be visible, e.g., in whose address books the user is included. Presence is typically binary, i.e., online or offline, and may be attached to a wide variety of applications.

In the messaging interface shown, the user can access a status menu (e.g., menu 106) which provides a number of options for controlling the user's online presence. That is, by selecting one of the available options the user can change the online presence indicator in his own messaging interface and the contact lists of the other users. In the example shown, a yellow smiley face indicates that the corresponding user is online, while a grey “sleepy” face indicates that the user is offline. As indicated in menu 106, there are a number of possible online states from which the user may select. The yellow smiley face without any associated symbols indicates the user is currently available.

Alternatively, a “busy” symbol or “badge” may be associated with or overlaid on the yellow smiley face to indicate that the user, while online, is currently busy with something else. As shown in menu 106, a number of options may be provided which indicate common reasons for being busy, e.g., “Not at My Desk,” or “On the Phone.” The user may also create his own “busy” options by selecting the “New Status Message . . . ” option and entering appropriate text when prompted. Other badges include, for example, a cell phone icon which indicates that the user is mobile, and a clock icon which indicates that the user is currently idle.

Despite the usefulness and popularity of online presence indicators, the manner in which online presence is currently indicated is not suitable for some applications.

### SUMMARY OF THE INVENTION

According to the present invention, methods and apparatus are provided for communicating an online presence of a group in a network. The group includes at least one member associated with the network. Each member of the group has an independent online status. A group presence indicator corresponding to the group is presented in a first interface in the network. The group presence indicator represents an online status of the group as being online or offline. The online status of each member of the group is not apparent from the group presence indicator. According to specific set of embodiments, in response to selection of the group presence indicator in the first interface, messaging is facilitated between a first user associated with the first interface and at least one member of the group.

A further understanding of the nature and advantages of the present invention may be realized by reference to the remaining portions of the specification and the drawings.

### BRIEF DESCRIPTION OF THE DRAWINGS

FIG. 1 illustrates an exemplary messaging interface according to the prior art.

FIG. 2 is a flowchart illustrating a specific embodiment of the invention.

FIGS. 3a-3d are block diagrams illustrating interaction between a group and a subscriber to the group presence according to various embodiments of the invention.

FIG. 4 is an exemplary interface in which a group presence indicator may be presented according to a specific embodiment of the invention.

FIG. 5 is an exemplary network diagram illustrating some of the platforms which may be employed with various embodiments of the invention

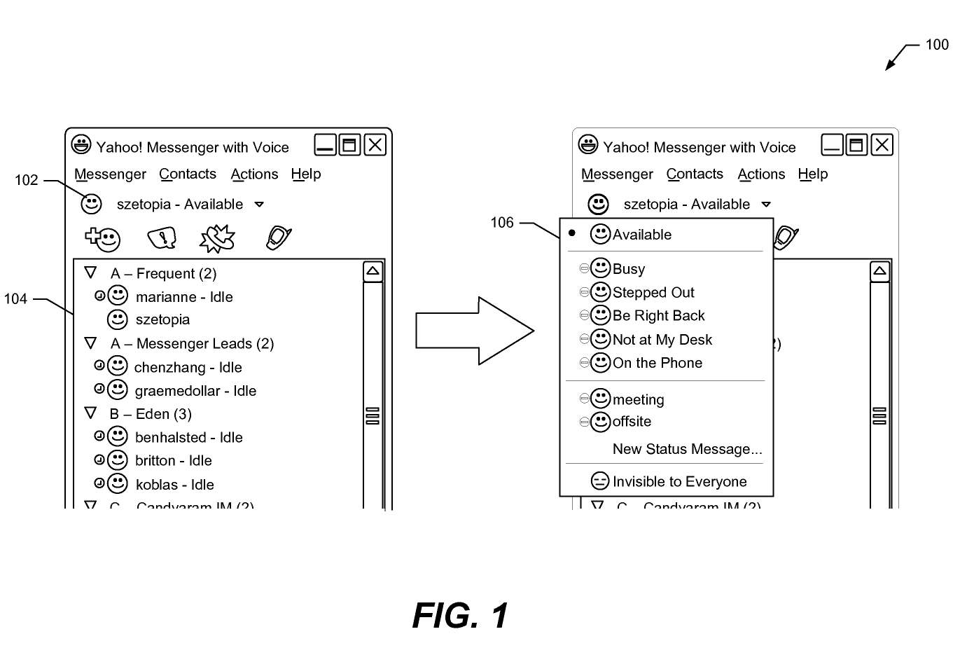

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

As mentioned above, representations of the online status of individuals may not be suitable for particular applications. For example, there are situations in which individual may want to indicate availability online in capacities other than their personal capacities. One such situation involves individuals who are members of an online technical support team. Customers seeking technical support do not need to be aware of the online status of specific members of the technical support team. Rather, for a number of reasons, it may be preferable to be able to communicate the online availability of the technical support team as a whole. Currently, there are no available mechanisms for this beyond providing an online presence indicator (OPI) for each available member of the team.

Therefore, according to various embodiments of the present invention, techniques are provided by which a single group OPI may be provided to represent the online presence of an entire group, each member of which has an associated online status. Specific embodiments of the invention will be described herein with reference to including such group OPIs in conjunction with and/or in the context of messaging applications. However, it should be noted at the outset that such implementations are merely provided as examples, and that group OPIs implemented according to the invention are much more widely applicable. That is, group OPIs implemented according to embodiments of the invention may be presented in a wide variety of contexts (e.g., on the Web, the Internet, intranets, extranets, etc.) and be associated with a wide variety of applications (e.g., messaging, web services, social networking, etc.).

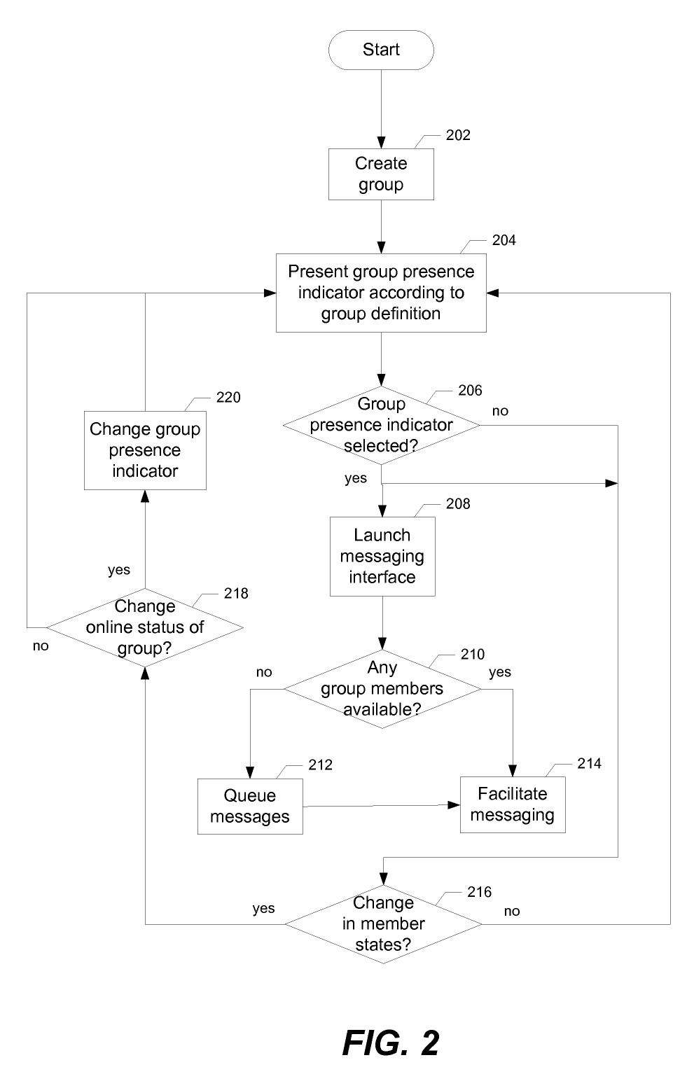

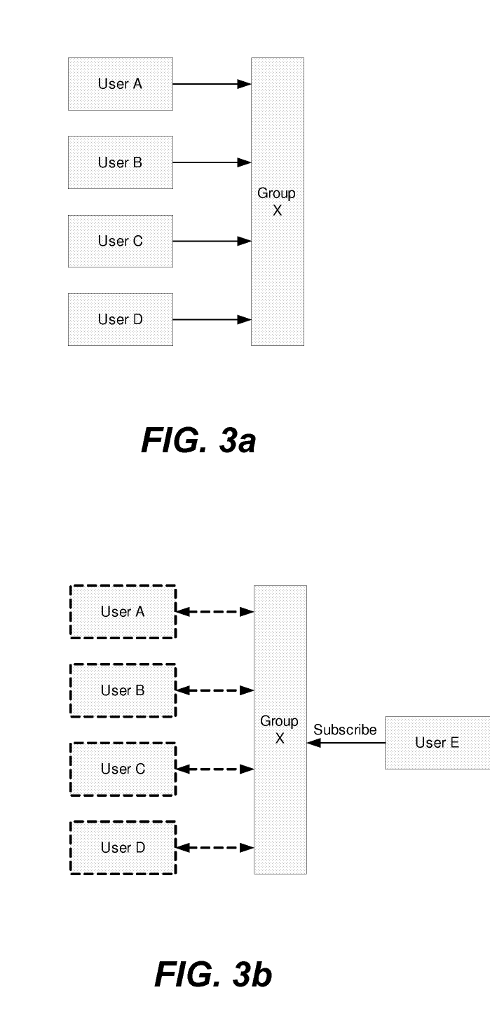

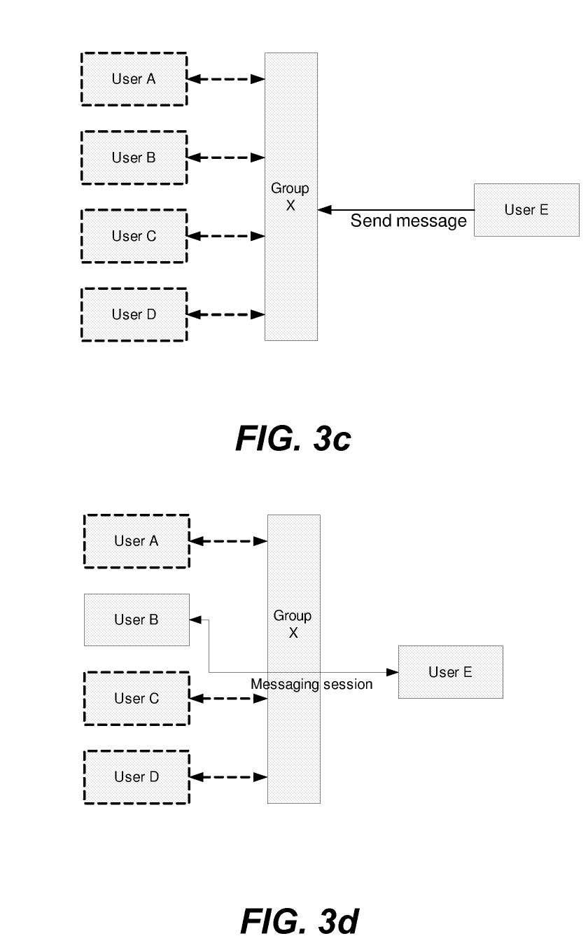

FIG. 2 is a flowchart which illustrates one class of embodiments of the present invention, and will be described with reference to the block diagrams of FIGS. 3a-3d. According to the invention, and as illustrated in FIG. 3a, any arbitrary set of users (A, B, C, and D) may form a group X having an associated group presence represented by a group OPI. As with OPIs associated with individuals in messaging applications (e.g., Yahoo! Messenger) and according to some embodiments of the invention, a group OPI may be a control object which, when selected, facilitates communication between subscribers to the group presence and the group. As used herein, “subscribers” are users and/or interfaces which are able to “see” the OPI for a group. “Members” are entities represented by a group. Typically, a group will also have at least one “moderator” or “administrator” who creates and maintains the group (202). Alternatively, ad hoc groups can be created without any moderator or administrator. For example, such a group could be created from a preexisting group of users, e.g., a Yahoo! Groups group, without input from a moderator.

According to some embodiments, an entity (e.g., an individual user, a network device, an automated process) may be both a member of a group as well as a subscriber to the group presence. In such embodiments, the group may be configured such that a member who is also a subscriber will not receive messages to the group which are initiated by himself. This may be implemented, for example, by comparing the source of each message to the group with the group membership to ensure that this type of message loop does not occur.

According to the invention, a group may be configured in a wide variety of ways. For example, the members of the group may or may not be able to identify other members of the group. That is, a group administrator may be the only member of the group who can access information regarding individual group members. And as described below, the online status of the group may be configured to be some combination of the online statuses of the group members, e.g., online if at least one of A, B, C, or D is online; online if all of A, B, C, and D are online; etc.

Once a group is created and configured in the desired manner, the group online presence indicator (OPI) is presented in its intended context (204). According to a specific embodiment, if a user selects the group OPI (206), a messaging interface is launched (208) with which the user may communicate with the group. According to various embodiments, the messaging interface may be associated with a wide range of messaging applications such as, for example, text messaging, SMS messaging, MMS messaging, electronic mail messaging, voice messaging, video messaging, photo sharing, file sharing, and web browsing.

The manner in which messages are delivered to the group may also be determined by the group configuration. For example, if group members are not currently available (210), messages addressed to the group may be held in a message queue or buffer (212). Buffered messages may then be delivered to members as they come on line, or be retrieved by group members from the buffer who can then initiate messaging (214). Alternatively, if group members are available, messaging with one of the available group members may be immediately facilitated (214).

In the case of voice messages, such messages may be stored in a group voicemail box from which group members may retrieve them. In such a case, the group administrator may control who can delete messages left in the group voicemail box. The group administrator may also exercise control over subscription to the group presence. The foregoing examples are only some of many, and should make apparent the many ways in which a group may be configured according to the invention. Some examples of particular implementations follow.

An example of a particular application of group presence may be instructive. In this example, a Yahoo! Support group has a group of technicians each of which has his own unique online status and his own Yahoo! Messenger buddy list. Users of Yahoo! Support can subscribe to the group presence of Yahoo! support (rather than the individual presences of the technicians) in much the same way that they can subscribe to the presence of individual users on various Yahoo! properties, e.g., Yahoo! Messenger. Selection of the group OPI initiates a messaging session with one of the technicians, or places a message from the user to the group in a buffer or queue for later retrieval and response by one of the technicians. Such a message buffer could be configured as a FIFO. Alternatively, messages in the buffer could have different priorities or queuing mechanisms. According to one such embodiment, the Yahoo! Support group OPI is configured to persistently show availability of the group even when none of the technicians is available, i.e., the presence of a group may be determined without regard to the individual presence statuses of the members of the group. Even if the group OPI indicates an offline status, message buffering can be used to store messages from users until a group member comes online. In either scenario, an automated response may be sent to the message originator indicating that his message was received and that a response is forthcoming.

And depending on how the group is configured, buffered messages may be accessed by members of the group in a variety of ways. For example, messages may be automatically pushed to group members as they come online. The manner in which messages are automatically pushed out to group members may be achieved in a variety of ways. For example, messages may be pushed to group members on a round-robin basis. Or messages may be pushed out one at a time as group members post responses. Or messages could be categorized and tagged according to subject matter, and then pushed to group members responsible for responding to messages relating to specific subject matter areas. Alternatively, group members may be notified that there are buffered messages so that they can retrieve them manually. As will be understood with reference to the foregoing examples, there are a wide variety of techniques by which messages may be communicated to group members that are within the scope of the invention.

As with individual OPIs, group OPIs implemented according to embodiments of the invention may include various secondary indicia representing more specificity for OPIs indicating the group is online. For example, the group could be indicated as online in mobile mode, online in SMS mode, online and busy, online and available, etc.

In addition, the individual statuses of the group members may be used to derive and represent additional group states beyond the binary “online” and “offline” designations. For example, the group OPI may be configured to change its online state depending on how many of the group members are currently online themselves. In the context of the support group example mentioned above, if 4 of 5 technicians are currently online and available, the group OPI might indicate that the support group is currently very responsive, e.g., the group OPI could be green. Alternatively, if only one of the technicians is currently online, or if technicians are online and busy, the group OPI might indicate that the current response time is slow, e.g., the group OPI could be yellow or red.

As mentioned above, a group may be configured with a layer of complexity built over the group which defines the rules by which the group is controlled. These rules or attributes are typically set by the moderator or creator upon group creation. Further examples of different ways in which a group may be configured are described below.

A group may be configured such that messages generated by group members (either to other group members or users outside the group) indicate only that the source of the messages is the group, i.e., the individual identity of the group member will typically be hidden. According to such embodiments, the messages in a thread may be tagged for a variety of purposes such as, for example, maintaining a thread between two individuals, or the monitoring of exchanges between users and support staff for quality control and other administrative purposes.

Alternatively, a group may be defined to include mechanisms by which the identity of individual group members may be exposed under certain circumstances. For example, in situations where a good working relationship develops between a particular technician and a user, the technician or the user can request that the technician's personal OPI be exposed for future communications. Alternatively, the technician may on his own initiative provide his contact information (e.g., messaging screen name) to the user.

A group represented by a group OPI may include an arbitrarily high number of members, but may also include as few as one. The use of a group OPI allows a company to keep its presence indicator sufficiently generic and allows the flexibility of changing group membership without affecting the address books or contact lists of users subscribing to the group's presence. For example, if a user has included the Yahoo! Messenger Support group in his Yahoo! Messenger Buddy list, then regardless of whether membership of the group changes over time, the user will still be able to monitor the group's online presence, and initiate communication with the group in a consistent and reliable manner. This is particularly advantageous for small companies where there might be turnover in such a group over time.

According to some embodiments, a group OPI implemented in accordance with the invention may be used to represent the roles of individuals in organization rather than the specific individuals themselves. For example, a company officer (e.g., a CFO) could be represented by a group OPI with the members of the group being at least the company's current CFO, and possibly additional members such as, for example, the CFO's assistant. Thus, regardless of who the current CFO is, an online presence may be provided which represents the current online availability of that officer, and facilitating communications which are relevant to that organizational role.

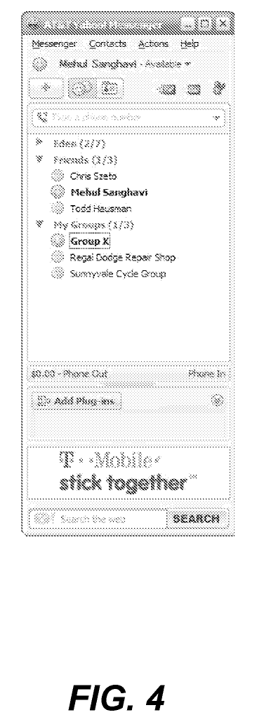

As shown in FIG. 3b, a user E may subscribe to group X in a manner which depends on how the group is set up. Assuming the group presence is open to any user, user E may subscribe to the group presence simply by adding group X to a contacts list, e.g., a Yahoo! Messenger buddy list (see FIG. 4), or by simply sending a message to group X. For groups which are not open to subscription by all users, attempts to add the group to a contacts list or to message with the group may result in a request to the group, the group administrator, or other group member to join the group. In this way, group membership may be controlled. For groups which are open to subscription by all users, responses to subscription requests can be automated.

FIG. 4 shows an example of an interface, i.e., a Yahoo! Messenger interface, in which group OPIs for Group X, Regal Dodge Repair Shop, and Sunnyvale Cycle Group are visible in the contacts or buddy list of a user. As shown, this is similar to the manner in which the OPIs for individuals may be presented and employed to initiate messaging. That is, the user to whom the buddy list belongs “subscribes” to the individual or group presence which then appears in his contact list. The OPIs in the user's contacts list then receive updates each time the user launches the messaging interface or each time a change in the online status of the corresponding users or groups occurs.

According to a specific embodiment, users may be invited to subscribe to a group presence using, for example, an instant message or an email message to extend the invitation and to provide the group ID. The invited user may then add the group to his contact list in a conventional manner.

As shown in FIGS. 3c and 3d, user E can send a message, make a voice call, or leave a voicemail for Group X. Depending on who responds (based on the group configuration setup), User E may then be engaged in a one-to-one conversation with any one of group X members A, B, C, or D (in this case B responds). According to a specific embodiment, selection of the Group X OPI in user E's Yahoo! Messenger buddy list launches an instant messaging interface with which user E engages in an instant messaging session with group member B.

In the case of the group OPI, and as alluded to elsewhere herein, there will typically be a layer of logic transparent to the subscriber which governs the underlying change in the status of the group. This logic maintains state for the group OPI based on the manner in which the group is configured. For example, the logic for a particular group OPI may be configured as a logical OR function such that as long as at least one member of the group is online, the group OPI indicates that the group is online. Thus, even though there may be significant and repeated changes in the online statuses of individual members of the group, updates to the group OPI will not be sent to the subscribers to the group presence unless and until all the group members are simultaneously offline.

As another alternative, a group OPI may be configured as a logical AND function such that the group OPI only indicates that the group is online if all or some subset of members are currently online. Such a group might be useful, for example, where communication is not desirable until a quorum is reached. As yet another alternative, a group OPI may be configured to persistently indicate that a group is online without reference to the online status of the individual group members.

More generally, and referring again to FIG. 2, where the online status of a group is determined with reference to the online statuses of the individual members, any changes in the members statuses (216) may, depending on how the group is configured, precipitate a change in the online status of the group (218) which, in turn, precipitates updates to the group OPIs currently visible in the network (220), e.g., in the buddy lists of subscribers to the group presence.

As alluded to above, embodiments of the invention enable representation of online presence with a finer granularity than conventional binary approaches. That is, because a group defined according to the invention may have multiple members, and because each member of a group has an independent online status, more than two states may exist and/or be represented for the group. One such example is outlined above in the context of a Yahoo! Messenger Support group. More generally, it will be understood that a wide variety of logical and algorithmic operations may be employed to maintain the underlying state of a group OPI and to represent that state without departing from the scope of the invention.

And while messaging interfaces such as the Yahoo! Messenger interface of FIG. 4 are an advantageous context in which to present group OPIs implemented according to the invention, it will be understood that group OPIs may be presented in a wide variety of interfaces without departing from the scope of the invention. For example, a group OPI may be presented on any web page for which Group X has relevance. This is not limited to pages associated with the Yahoo! network, but may include virtually any location on the Web or within a private network, i.e., anywhere a group wants users to be aware of its presence, and to be able to initiate communication with the group. In such implementations, the interface (e.g., the web page) on which the group OPI is presented may be thought of as the “subscriber” to the group presence. Other examples of interfaces in which group OPIs may be presented include, but are not limited to phone interfaces (e.g., VoIP applications), or directory interfaces (e.g., corporate directories such as LDAP directories).

Selection of the group OPI in such a context may result in the launching of a messaging application, e.g., Yahoo! Messenger, or lead the user through the necessary steps of downloading and installing such an application so that messaging with the group can be facilitated. Alternatively, a single group could have multiple OPIs on a site, each of which corresponds to a different messaging application, e.g., one for Yahoo!, one for MSN, etc.

The ability to represent group presence in a network and to facilitate communication with such a group enables a wide variety of applications which are useful to both consumers and companies. For example, as described above, individuals are able to efficiently communicate with entire groups via a variety of conventional messaging applications, e.g., group voice mail, group instant messaging, etc. The present invention enables creation of a group, e.g., a family or other social group, and the exposure of the presence of that group to those who subscribe or are given permission to see the group's presence. Subscribers to the group presence (which may include members of the group) could then initiate messaging with the group, e.g., group chat, without having to construct the group from the individual contacts in their contacts lists. Embodiments of the invention also enable a group subscriber to easily publish content (e.g., new blog posts), send updated contact information, or send meeting invites or other event information.

Moreover, a wide variety of applications beneficial to the enterprise are enabled which do not require the kind of IT investment which might otherwise be necessary. For example, in addition to the technical support applications mentioned above, group OPIs may be employed to enable customer relationship management (CRM) applications. In one such example, a group OPI may be configured to represent customer service reps who may be live from 8 am-5 pm. However, after 5 pm, the messages could be buffered, or responded to by an automated process (such as an IVR system) which is configured to answer simple questions. A wide variety of other consumer and commercial applications of the invention will be apparent to those of skill in the art.

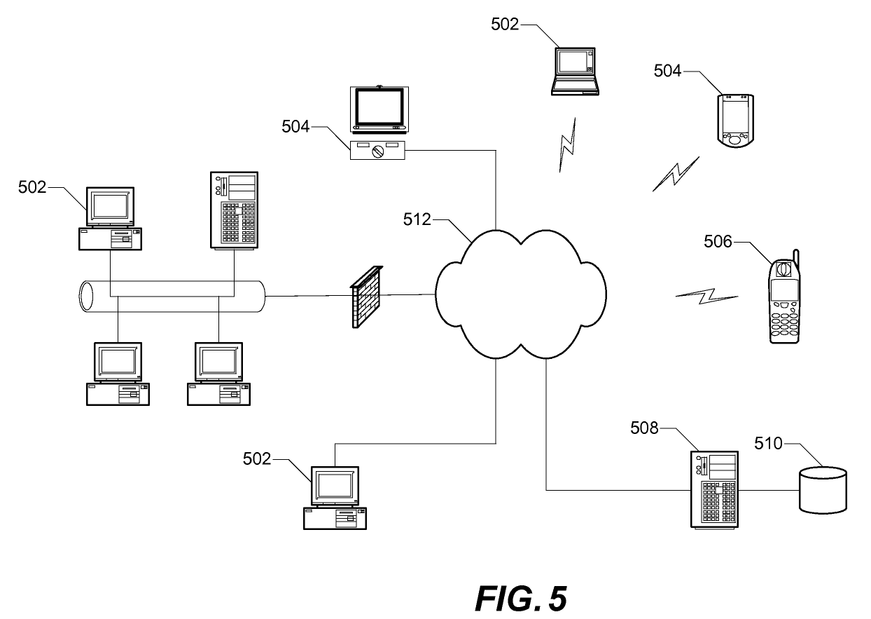

It should be noted that the present invention may be implemented on any computing platform(s) and in any network topology in which communicating online presence is a useful functionality. For example and as illustrated in FIG. 5, implementations are contemplated in which the OPIs and related functionalities described herein are provided on personal computers 502, media computing platforms 503 (e.g., gaming platforms, or cable and satellite set top boxes with navigation and recording capabilities), handheld computing devices (e.g., PDAs) 504, cell phones 506, or any other type of portable communication platform. Such OPIs and the related functionalities may be resident on such devices, e.g., as part of a browser or other application, or be served up from a remote site, e.g., in a Web page, (represented by server 508 and data store 510). The invention may also be practiced in a wide variety of network environments (represented by network 512), e.g., TCP/IP-based networks, telecommunications networks, wireless networks, etc.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention have been described herein in which the member of a group are human beings. However, it should be noted that embodiments are contemplated in which one or more members of a group for which online presence is represented may correspond to additional sub-groups or even automated processes operating in the network.

According to a specific embodiment, a group OPI may represent multiple underlying groups, each of which has an associated online status and may or may not have its own group OPI. In such a case, the higher level group OPI may have a layer of logic which aggregates the group statuses of the underlying member groups according to any of a wide variety of logical or algorithmic operations. In addition, embodiments are contemplated in which the members of a group may include both groups and individual entities.

In one example, a technical support group might include thousands of individuals. In such a case, it is useful to be able to organize the individuals in a hierarchy of subgroups with the individuals being associated as members to the lowest level of groups in the hierarchy. From the subscriber's point of view, there may be only a single technical support group OPI which is visible, but the group hierarchy may be constructed to facilitate messaging between the subscriber and a technician associated with the appropriate support sub-group. For example, a message from a subscriber could be tagged (e.g., according to an explicit selection by the subscriber or by parsing the message in some way) such that it will then be directed to the appropriate sub-group according to the logic associated with group(s). As will be understood, there may be an arbitrary number of levels to such a hierarchy with both groups and individuals represented on the various levels.

According to some embodiments, a group may include automated processes, e.g., “bots,” as members. For example, different automated online travel quote services may be aggregated behind such a group OPI. When a user is looking for a travel quote, he may select the travel group OPI (e.g., on a travel services web site) and request a quote for a particular itinerary. One or more of the automated services could then return a quote which is presented as coming from the group. According to a particular embodiment, quotes from multiple members of such a group may be aggregated in a single response from the group for comparison by the user.

Moreover, the “conversation” between a subscriber to the group presence and such an automated process could be conducted in natural language with the group logic and/or the automated process performing any necessary translation. This might involve an iterative process during which the user may be asked to confirm one or more translations of the user's request or question. Alternatively, the user could be prompted for specific information required by the automated process, e.g., using a form interface with specific field for the required information.

Finally, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

1. A computer-implemented method for communicating an online presence of a group in a network, the group comprising at least one member associated with the network, each member of the group having an independent online status, the method comprising presenting a group presence indicator corresponding to the group in a first interface in the network, the group presence indicator representing an online status of the group as being online or offline, the online status of each member of the group not being apparent from the group presence indicator.

2. The method of claim 1 further comprising, in response to selection of the group presence indicator in the first interface, facilitating messaging between a first user associated with the first interface and at least one member of the group.

3. The method of claim 2 wherein facilitating messaging comprises facilitating one or more of text messaging, SMS messaging, MMS messaging, electronic mail messaging, voice messaging, video messaging, photo sharing, file sharing, web browsing, launch of a messaging interface associated with a messaging application, or storage of at least one message from the first user for the at least one member of the group.

4. (canceled)

5. (canceled)

6. The method of claim 1 further comprising determining the online status of the group with reference to the online statuses of the members of the group.

7. The method of claim 6 wherein determining the online status of the group comprises determining a logical combination of the online statuses of the members of the group.

8. The method of claim 1 wherein the group presence indicator is configured to represent the online status of the group without reference to the online statuses of the members of the group.

9. The method of claim 1 wherein the first interface comprises any of a contacts list, a messaging interface, a web page, a phone interface, and a directory interface.

10. The method of claim 1 wherein the at least one member comprises any of a human, an automated process, and a subgroup having at least one member.

11. The method of claim 1 further comprising adding the group presence indicator to a contacts list associated with a first user associated with the first interface, the contacts list being associated with a messaging application.

12. The method of claim 1 wherein each member of the group has an individual presence indicator representing the online presence associated with the corresponding member.

13. (canceled)

14. The method of claim 1 wherein the group presence indicator is operable to represent a plurality of online states each of which represents availability for the group when the online status of the group indicates that the group is online.

15. A network comprising at least one network device which is operable to communicate an online presence of a group in a network, the group comprising at least one member associated with the network, each member of the group having an independent online status, the at least one network device being operable to present a group presence indicator corresponding to the group in a first interface in the network, the group presence indicator representing an online status of the group as being online or offline, the online status of each member of the group not being apparent from the group presence indicator.

16. The network of claim 15 wherein the at least one network device is further operable to facilitate messaging between a first user associated with the first interface and at least one member of the group in response to selection of the group presence indicator in the first interface.

17. The network of claim 16 wherein the at least one network device is operable to facilitate messaging by facilitating one or more of text messaging, SMS messaging, MMS messaging, electronic mail messaging, voice messaging, video messaging, photo sharing, file sharing, web browsing, or launch of a messaging interface associated with a messaging application.

18. (canceled)

19. The network of claim 15 wherein the at least one network device is further operable to determine the online status of the group with reference to the online statuses of the members of the group.

20. The network of claim 19 wherein the at least one network device is operable to determine the online status of the group by determining a logical combination of the online statuses of the members of the group.

21. The network of claim 15 wherein the group presence indicator is configured to represent the online status of the group without reference to the online statuses of the members of the group.

22. The network of claim 15 wherein the at least one member comprises any of a human, an automated process, and a subgroup having at least one member.

23. The network of claim 15 wherein each member of the group has an individual presence indicator representing the online presence associated with the corresponding member.

24. (canceled)

25. The network of claim 15 wherein the group presence indicator is operable to represent a plurality of online states each of which represents availability for the group when the online status of the group indicates that the group is online.

26. A device with which a first user may communicate with other users in a network including the device, the device comprising a display, a processor, memory, and an interface to the network, the processor being operable in conjunction with computer program instructions stored in the network to communicate an online presence of a group in a network, the group comprising at least one member associated with the network, each member of the group having an independent online status, the processor being operable in conjunction with the computer program instructions to present a group presence indicator corresponding to the group in a first interface on the display, the group presence indicator representing an online status of the group as being online or offline, the online status of each member of the group not being apparent from the group presence indicator.

27. The device of claim 26 wherein the processor is further operable in conjunction with the computer program instructions to facilitate messaging between the first user and at least one member of the group in response to selection of the group presence indicator in the first interface.

28. The device of claim 27 wherein the processor is operable to facilitate messaging by facilitating one or more of text messaging, SMS messaging, MMS messaging, electronic mail messaging, voice messaging, video messaging, photo sharing, file sharing, web browsing, or launch of a messaging interface associated with a messaging application.

29. (canceled)

30. The device of claim 26 wherein the first interface comprises any of a contacts list, a messaging interface, a web page, a phone interface, and a directory interface.

31. The device of claim 26 wherein the processor is further operable in conjunction with the computer program instructions to add the group presence indicator to a contacts list associated with the first user, the contacts list being associated with a messaging application.
